(19) United States
(12) Patent Application Publication
(10) Pub. No.: US 2007/0080516 A1
(43) Pub. Date: Apr. 12, 2007

(54) Trailer hitch assembly

(76) Inventor: Ronald Simmons, Bridgeport, TX (US)

Correspondence Address: David O. Simmons;Galasso & Associates LP, P.O. Box 26503, Austin, TX, 78755-0503, US

(21) Appl. No.: 11/521,938

(22) Filed: Sep. 15, 2006

Related U.S. Application Data
(60) Provisional application No. 60/724,741, filed on Oct. 7, 2005.

(51) Int. Cl. B60D 1/40; B60D 1/54

(52) U.S. Cl. 280/491.3; 280/478.1; 280/479.3

(57) ABSTRACT

A hitch assembly comprises a receiver body and a receiver tube. The receiver body includes a plurality of spaced-apart exterior walls defining an interior space therebetween. A first one of the wall defines an upper portion of the receiver body and a second one of the wall defines a lower portion of the receiver body. The receiver tube has a first end portion positioned within the interior space of the receiver body and a second end portion exposed at an opening in an edge portion of the receiver body. The first end portion of the receiver tube is pivotably attached to the receiver body for enabling the receiver tube to be pivoted laterally within the interior space.

### CROSS REFERENCE TO RELATED APPLICATIONS

This patent application claims priority to United States Provisional Patent Application having Ser. No. 60/724,741 filed Oct. 7, 2005 entitled “EZ Slide Hitch”, having a common applicant herewith and being incorporated herein in its entirety by reference.

### FIELD OF THE DISCLOSURE

The disclosures herein relate generally to trailer hitches and trailer hitch receivers, and more particularly to trailer hitch assemblies that simplify the hitching of a trailer to a tow vehicle.

### BACKGROUND

Connecting a tongue of a trailer to a trailer hitch of a tow vehicle using conventional approaches is often a tedious task. This is particularly true when the trailer cannot be readily manipulated by hand. For example, when the weight of a trailer and/or the orientation of the trailer (e.g., on an incline) is such that the trailer cannot be readily moved by hand for facilitating connection of the tongue of the trailer to the trailer hitch, the tow vehicle must be backed to either a position with the trailer hitch aligned under the tongue of the trailer or a position where only slight manual maneuvering of the trailer is required to align the trailer hitch with the tongue of the trailer.

For several reasons, such conventional approaches for connecting a tongue of trailer to a trailer hitch of a tow vehicle often require two people. Typically, a first person backs the vehicle under direction of a second person. The directions from the second person aid in aligning the trailer hitch to the tongue of the trailer and in precluding the tow vehicle from being accidentally backed into the tongue of the trailer. In some cases, such conventional approaches require two people because one person has to maneuver and hold the trailer in position (i.e., the tongue aligned over the trailer hitch) while a second person lowers the tongue of the trailer (e.g., via a hand crank) onto a ball of the trailer hitch.

Therefore, means for enabling a trailer hitch to be aligned with a tongue of a trainer in a manner that overcomes limitations associated with conventional trailer hitch assemblies and trailer-hitching approaches would be advantageous, desirable and useful.

### SUMMARY OF THE DISCLOSURE

Embodiments of the present invention simplify the task of coupling the tongue of a trailer to a trailer hitch. More specifically, embodiments of the present invention include a receiver tube that is angularly adjustable and a receiver hitch stub portion that is translatably adjustable. Accordingly, as opposed to manipulating a vehicle and/or trailer for achieving alignment of the tongue and receiver hitch, the receiver hitch is angularly and/or translatably adjusted for achieving such alignment thereby precluding the need for the a vehicle and trailer to be perfectly aligned prior to attaching the trailer tongue to the receiver hitch. Once aligned and engaged, the receiver tube and the receiver hitch are fixedly secured in respective towing positions. In this manner, embodiments of the present invention overcome limitations associated with conventional trailer hitch assemblies and trailer hitching approaches.

In one embodiment of the present invention, a hitch assembly comprises an upper plate, a lower plate and a receiver tube positioned between the upper plate and the lower plate. A first end portion of the receiver tube is pivotably attached to the upper plate and/or lower plate for enabling the receiver tube to be pivoted laterally between the upper plate and the lower plate. A second end portion of the receiver tube extends beyond an edge portion of the plates.

In another embodiment of the present invention, a hitch assembly comprises a receiver body and a receiver tube. The receiver body includes a plurality of spaced-apart exterior walls defining an interior space therebetween. A first one of the wall defines an upper portion of the receiver body and a second one of the wall defines a lower portion of the receiver body. The receiver tube has a first end portion positioned within the interior space of the receiver body and a second end portion exposed at an opening in an edge portion of the receiver body. The first end portion of the receiver tube is pivotably attached to the receiver body for enabling the receiver tube to be pivoted laterally within the interior space.

In another embodiment of the present invention, a hitch assembly comprises a receiver body, a receiver tube, a receiver hitch stub portion, means for fixedly securing the receiver tube in a respective towing position and means for fixedly securing the receiver hitch stub portion in a respective towing position. The receiver body has an interior space and an opening through which the interior space is accessible. The receiver tube has a first end portion positioned within an interior space of the receiver body and a second end portion extending from within the interior space through the opening. The first end portion of the receiver tube is pivotably attached to the receiver body for enabling the receiver tube to be pivoted laterally within the interior space between the respective towing position and a plurality of angularly displaced positions. The receiver hitch stub portion is translatably mounted within a longitudinally extending passage of the receiver tube for enabling the receiver hitch stub portion to be translated between the respective towing position and a plurality of non-towing positions.

Turning now to specific aspects of the present invention, in at least one embodiment, the receiver tube is pivotable between a respective towing position and a plurality of angularly displaced positions, vertically aligned holes are provided in upper and lower wall portions of the receiver body, a first set of the vertically aligned holes is adjacent a first side face of the receiver tube when the receiver tube is in the respective towing position and a second set of the vertically aligned holes is adjacent a second side face of the receiver tube when the receiver tube is in the respective towing position.

In at least one embodiment of the present invention, a receiver hitch stub portion is translatably mounted within a longitudinally extending passage of the receiver tube.

In at least one embodiment of the present invention, a travel limiting structure of the receiver hitch stub portion engages a mating travel limiting structure of the receiver tube for limiting an insertion depth of the receiver hitch stub portion within the longitudinally extending passage and for limiting a distance that the receiver hitch stub portion is extendable from within the longitudinally extending passage.

In at least one embodiment of the present invention, the receiver tube includes a locking member passage extending therethrough, the receiver hitch stub portion includes a locking member passage extending therethrough and the receiver hitch stub portion is translatable to a position where the locking member passage of the receiver hitch stub portion is aligned with the locking member passage of the receiver tube for enabling a locking member to be simultaneously disposed within both of the locking member passages.

In at least one embodiment of the present invention, the travel limiting structure of the receiver hitch stub portion includes a guide member fixedly attached to the receiver hitch stub portion, the mating travel limiting structure of the receiver tube includes a guide member slot in a sidewall of the receiver tube that defines the longitudinally extending passage, the guide member is disposed within the guide member slot and the guide member slot extends parallel with the longitudinally extending passage of the receiver tube.

In at least one embodiment of the present invention, the means for fixedly securing the receiver tube in the respective towing position includes vertically aligned holes in the upper and lower portions of the receiver body.

In at least one embodiment of the present invention, the means for fixedly securing the receiver hitch stub portion in the respective towing position includes a locking member passage extending through the receiver tube and a locking member passage extending through the receiver hitch stub portion such that the receiver hitch stub portion is translatable to a position where the locking member passage of the receiver hitch stub portion is aligned with the locking member passage of the receiver tube for enabling a locking member to be simultaneously disposed within both of the locking member passages.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a perspective view showing an embodiment of a hitch assembly in accordance with the present invention.

FIG. 2 is a cross sectional view taken along the line 2-2 in FIG. 1.

### DETAILED DESCRIPTION OF THE DRAWING FIGURES

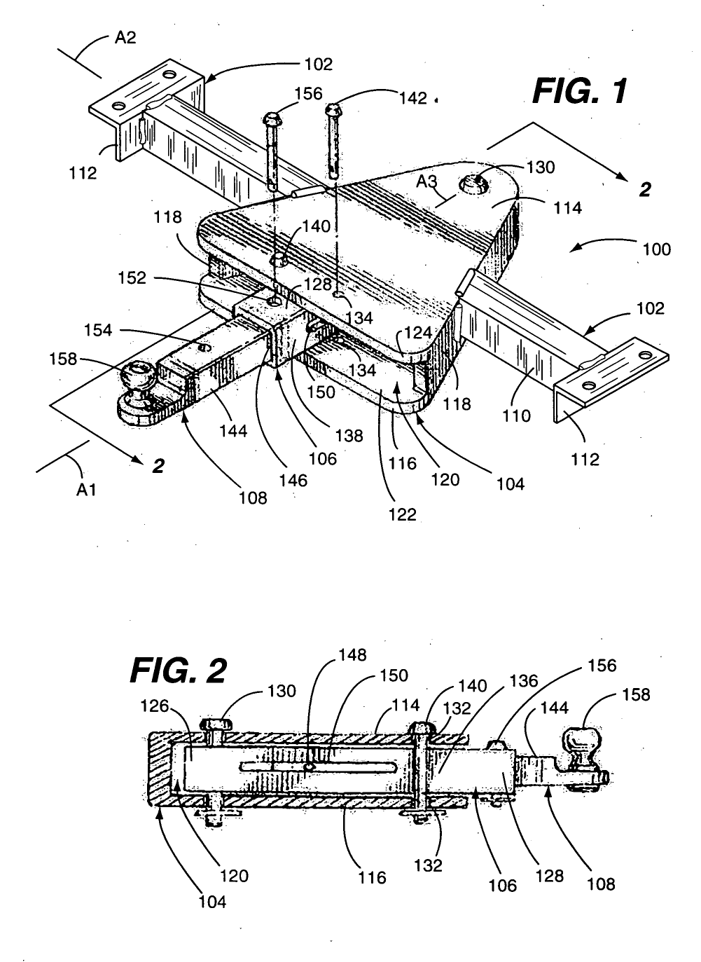

FIGS. 1 and 2 show an embodiment of a hitch assembly in accordance with the present invention, which is referred to herein as the hitch assembly 100. The hitch assembly 100 includes a mounting structures 102, a receiver body 104, a receiver tube 106 and a receiver hitch 108. Preferably, but not necessarily, the mounting structure 102, the receiver body 104, the receiver tube 106 and the receiver hitch 108 are made from steel. A skilled person will be well aware of known materials and fabrication techniques for making hitch assemblies and such known materials and fabrication techniques may be applied to hitch assemblies in accordance with the present invention.

The mounting structures 102 each include a crossbar 110 and a mounting bracket 1.12 attached to each opposing end of the crossbar 110. The crossbar 110 is fixedly attached to the receiver body 104 by means such as, for example, welding, threaded fasteners, etc and the mounting brackets 112 are configured for being attached to a chassis of a vehicle. Similarly, the mounting brackets 112 are attached to the crossbar 110 by means such as, for example, welding, threaded fasteners, etc opposing end of the crossbar 110. Thus, the hitch assembly 100 is suitably configured for being attached to a chassis of a vehicle for providing towing functionality. It is disclosed herein that the crossbar 110 may have one of any number of different configurations. For example, the crossbar 110 may extend contiguously between the mounting brackets 112 whereby it is abutted against the top plate 114 or bottom plate 116 of the receiver body 104. The present invention is not limited to any particular configuration of crossbar.

The receiver body 104 includes an upper plate 114, a lower plate 116 and side plates 118. The upper plate 114, the lower plate 116 and the side plates 118 are fixedly adjoined by means such as welding whereby the upper plate 114, the lower plate 116 and the side plates 118 form spaced-apart exterior walls that define an interior space 120 therebetween. The wall corresponding to the upper plate 114 defines an upper portion of the receiver body 104 and the wall corresponding to the lower plate 116 defines a lower portion of the receiver body 104. The interior space 120 of the receiver body 104 is accessible through an opening 122 in an edge portion 124 of the receiver body 104.

The receiver tube 106 has a first end portion 126 (FIG. 2) positioned within the interior space 120 of the receiver body 104 and a second end portion 128 extending from within the interior space 120 through the opening 122. It is disclosed herein that, alternatively, the length of the receiver tube 106 may be such that the second end portion 128 of the receiver tube 106 is exposed at and accessible through the opening 122 as opposed to extending from within the interior space 120. A pivot member 130 (e.g., a clevis pin) extends through the first end portion 126 of the receiver tube 106 and the upper and lower plates (114, 116) of the receiver body 104. Alternatively, the receiver tube may be pivotably attached to the upper plate 114 or the lower plate 116. In this manner, the receiver tube 106 is pivotably attached to the receiver body 104 for enabling the receiver tube 106 to be pivoted laterally within the interior space 120. Such lateral pivoting is constrained about a pivot axis that extends approximately perpendicular to the upper and lower plates (114, 116) of the receiver body 104.

The receiver tube 106 is pivotable between a respective towing position T and a plurality of angularly displaced positions D 1. The towing position T is defined herein as a longitudinal axis A1 of the receiver tube 106 being essentially perpendicular to a transverse reference axis A2 of the crossbar 110. Each angularly displaced positions is defined herein as the longitudinal axis A1 of the receiver tube 106 being substantially skewed with respect to the transverse reference axis A2 of the crossbar 110.

A first set of vertically aligned holes (i.e., first hole set 132) is provided in the upper plate 114 and lower plate 116 and a second set of vertically aligned holes (i.e., second hole set 134) is provided in the upper plate 114 and lower plate 116. The first hole set 132 is adjacent a first side face 136 of the receiver tube 106 when the receiver tube 106 is in the respective towing position T. The second hole set 134 is adjacent a second side face 138 of the receiver tube 106 when the receiver tube 106 is in the respective towing position T. When the receiver tube 106 is in the towing position T, a first locking member 140 and a second locking member 142 are engaged with the first hole set 132 and the second hole set 134, respectively, for securing the receiver tube 106 in the towing position T by limiting unrestricted pivoting of the receiver tube 106. When one or both of the locking members (140, 142) are removed from the respective hole set (132, 134), the receiver tube 106 may be pivoted laterally in one or both directions with respect to the towing position T. As shown in FIG. 2, a means for retention (e.g., a clip, cotter pin, etc) is used for selectively securing the locking member (140, 142) in place. For enabling hitching functionality in accordance with the present invention (discussed below), the hole sets (132, 134) are equidistant from a reference axis that extends through the pivot member 130 lines and that is perpendicular to the transverse reference axis A2 of the crossbar 110.

Implementation of the hole sets (132, 134) and locking members (140, 142) is one embodiment of a means for fixedly securing a receiver tube in a respective towing position in accordance with the present invention. It is disclosed herein that the present invention is not unnecessarily limited to a particular embodiment or embodiments of means for fixedly securing a receiver tube in a respective towing position. One alternate embodiment of means for fixedly securing a receiver tube in a respective towing position includes a slideable retention member attached to the receiver body that engages a mating structure (e.g., hole, sleeve, etc) of the receiver tube. Another alternate embodiment of means for fixedly securing a receiver tube in a respective towing position includes a slideable retention member attached to the receiver tube that engages a mating structure (e.g., hole, sleeve, etc) of the receiver body. It is disclosed herein that the locking members (140, 142) may each be a discrete element that is completely detachable from the receiver body 104. It is further disclosed herein that, alternatively, the locking members (140, 142) may each be translatably mounted on the receiver body 104 in a spring loaded manner such that they can each be translated between a spring-biased at-rest position where each one extends fully between the upper and lower plates (114, 116) of the receiver body 104 and a displaced position where each is manually retracted from the interior space 120 of the receiver body 104.

The receiver hitch 108 includes a stub portion 144 (i.e., the receiver hitch stub portion 144). The receiver hitch stub portion 144 is translatably mounted within a longitudinally extending passage 146 of the receiver tube 106 whereby a depth of insertion of the receiver hitch stub portion 144 is variable. A guide member 148 (e.g., a pin) is fixedly attached to the receiver hitch stub portion 144 and a guide member slot 150 is provided in a sidewall 152 of the receiver tube 106 that defines the longitudinally extending passage 146. The guide member 148 is disposed within the guide member slot 150 and the guide member slot 150 extends parallel with the longitudinally extending passage 146 of the receiver tube 106. Jointly, the guide member 148 and the guide member slot 150 serve to limit an insertion depth of the receiver hitch stub portion 144 within the longitudinally extending passage 146 and for limiting a distance that the receiver hitch stub portion 144 is extendable from within the longitudinally extending passage 146. It is disclosed herein that, alternatively, the guide member 148 may be fixedly attached to the receiver body 106 and the guide member slot 150 may be formed in the receiver hitch stub portion 144.

The guide member 148 is an embodiment of a travel limiting structure of the receiver hitch stub portion 144 and the guide member slot 150 is an embodiment of a mating travel limiting structure of the receiver tube 106. It is disclosed herein that other embodiments of the travel limiting structures may be implemented. For example, the travel limiting structures may be screws threaded into the receiver hitch stub portion 144 whereby a first screw head limits insertion depth and a second screw head limits extension distance. It is further disclosed herein that discrete the travel limiting structures (e.g., the guide member 148 and the guide member slot 150) may be omitted entirely without precluding the advantageous functionality of the hitch assembly 100.

The receiver tube 106 includes a locking member passage 152 extending therethrough and the receiver hitch stub portion 144 includes a locking member passage 152 extending therethrough. The receiver hitch stub portion 144 is translatable to a position where the locking member passage 154 of the receiver hitch stub portion 144 is alignable with the locking member passage 152 of the receiver tube 106 for enabling a locking member 156 (e.g., a pin) to be simultaneously disposed within both of the locking member passages (152, 154). It is disclosed herein that the locking member 156 may be a discrete element that is completely detachable from the receiver tube 106 and receiver hitch stub portion 144. It is further disclosed herein that, alternatively, the locking member 156 may be translatably mounted on the receiver tube in a spring loaded manner such that it can be translated between an at-rest spring-biased position where it is engaged within the locking member passage 152 of the receiver tube 106 and the locking member passage 154 of the receiver hitch stub portion 144 and a manually displaced position where it is disengaged from within the locking member passage 154 of the receiver hitch stub portion 144. Still further, it is disclosed herein that the locking member 156 is not limited to a particular direction of translation. The locking member passages (152, 154) may be orientated such that translation of the locking member 156 is vertical (as shown) or horizontally.

As shown in FIG. 2, a means for retention (e.g., a clip, cotter pin, etc) is used for selectively securing the locking member 156 in place. For enabling hitching functionality in accordance with the present invention (discussed below), the respective relative positions of the locking member passages (152, 154) are such that the receiver hitch stub portion 144 is fully inserted into the receiver tube 106 when the locking member passages (152, 154) are aligned. The locking member passages (152, 154) and the locking member 156 are jointly an embodiment of means for fixedly securing the receiver hitch stub portion 144 in a respective towing position (i.e., the position where the locking member 156 is disposed within both of the locking member passages (152, 154)).

In use, the hitch assembly 100 is attached to the rear (or front) of a vehicle. To facilitate hitching of the vehicle to a trailer, the locking members (140, 142) and the locking member 156 are removed. The vehicle is moved into a position where a tongue ball 158 of the receiver hitch stub portion 144 is within a few inches of a ball receiving portion of a tongue of the trailer. The hitch ball 158 of the receiver hitch stub portion 144 is then brought into alignment with the ball receiving portion of the trailer tongue by angularly and translatably manipulating the position of the hitch ball 158. With the hitch ball 158 aligned with the ball receiving portion of the trailer tongue, the ball receiving portion of the trailer tongue is lowered onto the hitch ball 158. After properly securing the ball receiving portion of the trailer tongue to the hitch ball 158, the vehicle is moved in a direction way from the trailer such that the receiver tube 106 self-centers between the hole set (132, 134) in the receiver body 104. The locking members (140, 142) are then installed to secure the receiver tube 106 in the towing position T1. The vehicle is then moved toward the trailer for bottoming the receiver hitch stub portion 144 within the receiver tube (i.e., self-aligning of the locking member passages (152, 154)), thus enabling the locking member 156 to be engaged with the locking member passages (152, 154).

In the case where travel limiting structure of the receiver hitch stub portion 144 and the guide member slot 150 is omitted, after properly securing the ball receiving portion of the trailer tongue to the hitch ball 158, the vehicle is first moved toward the trailer for enabling the locking member passages (152, 154) of the receiver tube 106 and receiver hitch stub portion 144 to be aligned and the locking member 156 to be engaged with the locking member passages (152, 154). The vehicle is then moved in a direction way from the trailer such that the receiver tube 106 self-centers between the hole set (132, 134) in the receiver body 104. The locking members (140, 142) are then installed to secure the receiver tube 106 in the towing position T1.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A hitch assembly, comprising:
an upper plate;
a lower plate; and
a receiver tube positioned between said plates;
wherein a first end portion of the receiver tube is pivotably attached to at least one of said plates for enabling the receiver tube to be pivoted laterally between said plates; and
wherein a second end portion of the receiver tube extends beyond an edge portion of said plates.

2. The hitch assembly of claim 1 wherein:
the receiver tube is pivotable between a respective towing position and a plurality of angularly displaced positions;
vertically aligned holes in said upper and lower plates;
a first set of said vertically aligned holes is adjacent a first side face of the receiver tube when the receiver tube is in the respective towing position; and
a second set of said vertically aligned holes is adjacent a second side face of the receiver tube when the receiver tube is in the respective towing position.

3. The hitch assembly of claim 1, further comprising:
a receiver hitch stub portion translatably mounted within a longitudinally extending passage of the receiver tube, wherein a travel limiting structure of the receiver hitch stub portion engages a mating travel limiting structure of the receiver tube for limiting an insertion depth of the receiver hitch stub portion within the longitudinally extending passage and for limiting a distance that the receiver hitch stub portion is extendable from within the longitudinally extending passage.

4. The hitch assembly of claim 3 wherein:
the receiver tube includes a locking member passage extending therethrough;
the receiver hitch stub portion includes a locking member passage extending therethrough; and
the receiver hitch stub portion is translatable to a position where the locking member passage of the receiver hitch stub portion is aligned with the locking member passage of the receiver tube for enabling a locking member to be simultaneously disposed within both of said locking member passages.

5. The hitch assembly of claim 4 wherein:
the travel limiting structure of the receiver hitch stub portion includes a guide member fixedly attached to the receiver hitch stub portion;
the mating travel limiting structure of the receiver tube includes a guide member slot in a sidewall of the receiver tube that defines the longitudinally extending passage;
the guide member is disposed within the guide member slot; and
the guide member slot extends parallel with the longitudinally extending passage of the receiver tube.

6. The hitch assembly of claim 5 wherein:
the receiver tube is pivotable between a respective towing position and a plurality of angularly displaced positions;
vertically aligned holes in said upper and lower;
a first set of said vertically aligned holes is adjacent a first side face of the receiver tube when the receiver tube is in the respective towing position; and
a second set of said vertically aligned holes is adjacent a second side face of the receiver tube when the receiver tube is in the respective towing position.

7. A hitch assembly, comprising:
a receiver body including a plurality of spaced-apart exterior walls defining an interior space therebetween, wherein a first one of said wall defines an upper portion of the receiver body and a second one of said wall defines a lower portion of the receiver body; and
a receiver tube having a first end portion positioned within the interior space of the receiver body and a second end portion exposed at an opening in an edge portion of the receiver body, wherein the first end portion of the receiver tube is pivotably attached to the receiver body for enabling the receiver tube to be pivoted laterally within the interior space.

8. The hitch assembly of claim 7 wherein:
the receiver tube is pivotable between a respective towing position and a plurality of angularly displaced positions;
vertically aligned holes in said upper and lower portions of the receiver body;
a first set of said vertically aligned holes is adjacent a first side face of the receiver tube when the receiver tube is in the respective towing position; and
a second set of said vertically aligned holes is adjacent a second side face of the receiver tube when the receiver tube is in the respective towing position.

9. The hitch assembly of claim 7, further comprising:
a receiver hitch stub portion translatably mounted within a longitudinally extending passage of the receiver tube, wherein a travel limiting structure of the receiver hitch stub portion engages a mating travel limiting structure of the receiver tube for limiting an insertion depth of the receiver hitch stub portion within the longitudinally extending passage and for limiting a distance that the receiver hitch stub portion is extendable from within the longitudinally extending passage.

10. The hitch assembly of claim 9 wherein:
the receiver tube includes a locking member passage extending therethrough;
the receiver hitch stub portion includes a locking member passage extending therethrough; and
the receiver hitch stub portion is translatable to a position where the locking member passage of the receiver hitch stub portion is aligned with the locking member passage of the receiver tube for enabling a locking member to be simultaneously disposed within both of said locking member passages.

11. The hitch assembly of claim 10 wherein:
the travel limiting structure of the receiver hitch stub portion includes a guide member fixedly attached to the receiver hitch stub portion;
the mating travel limiting structure of the receiver tube includes a guide member slot in a sidewall of the receiver tube that defines the longitudinally extending passage;
the guide member is disposed within the guide member slot; and
the guide member slot extends parallel with the longitudinally extending passage of the receiver tube.

12. The hitch assembly of claim 11 wherein:
the receiver tube is pivotable between a respective towing position and a plurality of angularly displaced positions;
vertically aligned holes in said upper and lower portions of the receiver body;
a first set of said vertically aligned holes is adjacent a first side face of the receiver tube when the receiver tube is in the respective towing position; and
a second set of said vertically aligned holes is adjacent a second side face of the receiver tube when the receiver tube is in the respective towing position.

13. A hitch assembly, comprising:
a receiver body having an interior space and an opening through which the interior space is accessible;
a receiver tube having a first end portion positioned within an interior space of the receiver body and a second end portion extending from within the interior space through the opening, wherein the first end portion of the receiver tube is pivotably attached to the receiver body for enabling the receiver tube to be pivoted laterally within the interior space between a respective towing position and a plurality of angularly displaced positions;
a receiver hitch stub portion translatably mounted within a longitudinally extending passage of the receiver tube for enabling the receiver hitch stub portion to be translated between a respective towing position and a plurality of non-towing positions;
means for fixedly securing the receiver tube in the respective towing position; and
means for fixedly securing the receiver hitch stub portion in the respective towing position.

14. The hitch assembly of claim 13 wherein:
said means for fixedly securing the receiver tube in the respective towing position includes vertically aligned holes in said upper and lower portions of the receiver body;
a first set of said vertically aligned holes adjacent a first side face of the receiver tube when the receiver tube is in the respective towing position; and
a second set of said vertically aligned holes adjacent a second side face of the receiver tube when the receiver tube is in the respective towing position.

15. The hitch assembly of claim 13 wherein:
said means for fixedly securing the receiver hitch stub portion in the respective towing position includes a locking member passage extending through the receiver tube and a locking member passage extending through the receiver hitch stub portion; and
the receiver hitch stub portion is translatable to a position where the locking member passage of the receiver hitch stub portion is aligned with the locking member passage of the receiver tube for enabling a locking member to be simultaneously disposed within both of said locking member passages.

16. The hitch assembly of claim 13 wherein:
a travel limiting structure of the receiver hitch stub portion engages a mating travel limiting structure of the receiver tube for limiting an insertion depth of the receiver hitch stub portion within the longitudinally extending passage and for limiting a distance that the receiver hitch stub portion is extendable from within the longitudinally extending passage.

17. The hitch assembly of claim 16 wherein:
the travel limiting structure of the receiver hitch stub portion includes a guide member fixedly attached to the receiver hitch stub portion;
the mating travel limiting structure of the receiver tube includes a guide member slot in a sidewall of the receiver tube that defines the longitudinally extending passage; and
the guide member slot extends parallel with the longitudinally extending passage of the receiver tube.

18. The hitch assembly of claim 17 wherein:
said means for fixedly securing the receiver tube in the respective towing position includes vertically aligned holes in said upper and lower portions of the receiver body;
a first set of said vertically aligned holes is adjacent a first side face of the receiver tube when the receiver tube is in the respective towing position; and
a second set of said vertically aligned holes is adjacent-a second side face of the receiver tube when the receiver tube is in the respective towing position.

19. The hitch assembly of claim 18 wherein:
said means for means for fixedly securing the receiver hitch stub portion in the respective towing position includes a locking member passage extending through the receiver tube and a locking member passage extending through the receiver hitch stub portion; and
the receiver hitch stub portion is translatable to a position where the locking member passage of the receiver hitch stub portion is aligned with the locking member passage of the receiver tube for enabling a locking member to be simultaneously disposed within both of said locking member passages.
